(19) United States
(12) Patent Application Publication
(10) Pub. No.: US 2025/0210849 A1
(43) Pub. Date: Jun. 26, 2025

(54) Laptop Computer with Phased Antenna Array

(71) Applicant: Apple Inc., Cupertino, CA (US)

(72) Inventors: Menglou Rao, Austin, TX (US); Jerzy S. Guterman, Sunnyvale, CA (US); Panagiotis Theofanopoulos, Cupertino, CA (US); Joel D. Barrera, Cedar Park, TX (US)

(21) Appl. No.: 18/390,678

(22) Filed: Dec. 20, 2023

(51) Int. Cl. H01Q 1/22; H01Q 3/36

(52) U.S. Cl. CPC H01Q 1/2266; H01Q 3/36

(57) ABSTRACT

An electronic device such as a laptop computer may have upper and lower housings. The upper housing may be coupled to the lower housing by a hinge having a hinge axis. The lower housing may have an upper metal wall, a lower metal wall, and an angled metal wall that extends from the upper metal wall towards the lower metal wall. The lower housing may include a phased antenna array with a set of antennas aligned along a linear axis. The phased antenna array may be aligned with a dielectric window in the upper metal wall and may be oriented such that the linear axis is orthogonal to the hinge axis, or may be aligned with a dielectric window in the angled metal wall. One or more processors may adjust the phased antenna array based on the position of the upper housing relative to the lower housing.

### FIELD

This relates generally to electronic devices, including electronic devices with wireless communications capabilities.

### BACKGROUND

Electronic devices such as portable computers and cellular telephones are often provided with wireless communications capabilities and displays. To satisfy consumer demand for small form factor wireless devices, manufacturers are continually striving to implement wireless communications circuitry such as antenna components using compact structures.

It can be challenging to form antennas with desired attributes. In some devices, the presence of conductive housing structures can block or otherwise deteriorate antenna performance.

### SUMMARY

An electronic device such as a laptop computer may have an upper housing and a lower housing. The upper housing may be coupled to the lower housing by a hinge having a hinge axis. The upper housing may be rotatable relative to the lower housing between a fully open position and a closed position about the hinge axis. The lower housing may have an upper metal wall, a lower metal wall, and a metal sidewall that couples the lower metal wall to the upper metal wall. The lower metal housing may have an angled metal wall that extends from the upper metal wall towards the lower metal wall at a lateral periphery of the lower metal wall. The angled metal wall may form a finger scoop for the upper housing if desired.

The electronic device may include wireless circuitry. The wireless circuitry may include one or more phased antenna arrays. Each phased antenna array may have a set of antennas aligned along a linear axis (e.g., a longitudinal axis of the phased antenna array). The phased antenna array may be a linear array as one example. The phased antenna array(s) may be disposed in the lower housing. A phased antenna array may be aligned with a dielectric window in the upper metal wall and may be oriented such that the linear axis is orthogonal to the hinge axis. If desired, a lid position sensor may detect a position (e.g., orientation or angle) of the upper housing relative to the lower housing about the hinge axis. One or more processors may adjust the phased antenna array based on the detected position to optimize wireless performance. If desired, a phased antenna array may be aligned with a dielectric window in the angled metal wall.

### BRIEF DESCRIPTION OF THE DRAWINGS

FIG. 1 is a perspective view of an illustrative electronic device such as a laptop computer in accordance with some embodiments.

FIG. 2 is a schematic diagram of an illustrative electronic device with wireless circuitry in accordance with some embodiments.

FIG. 3 is a diagram of an illustrative phased antenna array in accordance with some embodiments.

FIG. 4 is a perspective view of an illustrative patch antenna that may be implemented in a phased antenna array in accordance with some embodiments.

FIG. 5 is a perspective view of an illustrative antenna module having patch antennas in accordance with some embodiments.

FIG. 6 is a cross-sectional side view showing how an illustrative antenna module may be aligned with an aperture in a conductive housing wall of an electronic device in accordance with some embodiments.

FIG. 7 is a cross-sectional side view of an illustrative antenna module that is aligned with an aperture in an angled conductive housing wall of a lower housing of an electronic device in accordance with some embodiments.

FIG. 8 is a perspective view of an illustrative electronic device having a phased antenna array that is aligned with an aperture in an upper conductive housing wall of a lower housing in accordance with some embodiments.

FIG. 9 is a side view showing how an illustrative phased antenna array of the type shown in FIG. 8 may be adjusted based on the lid position of an upper housing of an electronic device in accordance with some embodiments.

FIG. 10 is a flow chart of illustrative operations involved in conveying radio-frequency signals using a phased antenna array that is adjusted based on the lid position of a laptop computer in accordance with some embodiments.

### DETAILED DESCRIPTION

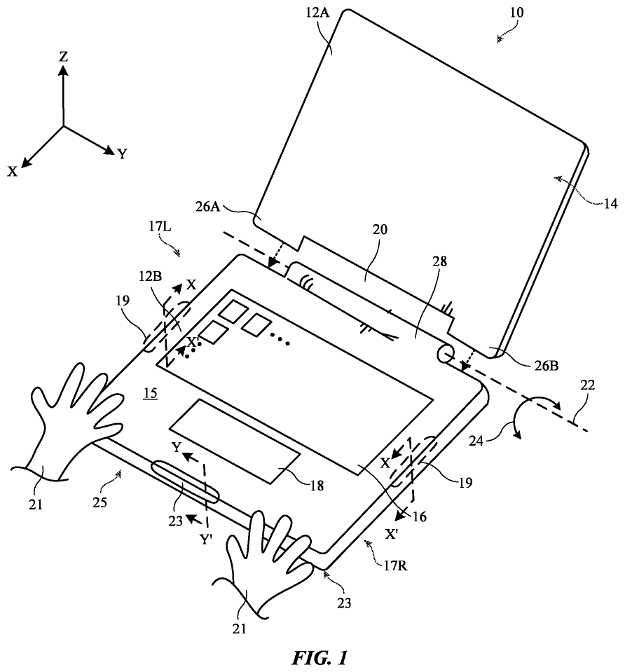

An electronic device such as electronic device 10 of FIG. 1 may contain wireless circuitry. For example, electronic device 10 may contain wireless communications circuitry that includes antennas that operate in long-range communications bands such as cellular telephone bands and that operate in short-range communications bands such as the 2.4 GHz Bluetooth® or other wireless personal area network (WPAN) bands and the 2.4 GHz and 5 GHz Wi-Fi® band or other wireless local area network (WLAN) bands (sometimes referred to as IEEE 802.11 bands or wireless local area network communications bands). Device 10 may also contain antennas that are arranged in a phased antenna array. The phased antenna array may perform wireless communications and/or spatial ranging operations using millimeter and centimeter wave signals. Millimeter wave signals, which are sometimes referred to as extremely high frequency (EHF) signals, propagate at frequencies above about 30 GHz (e.g., at 60 GHz or other frequencies between about 30 GHz and 300 GHz). Centimeter wave signals propagate at frequencies between about 10 GHz and 30 GHz. If desired, device 10 may also contain antennas for handling satellite navigation system signals, cellular telephone signals, local wireless area network signals, near-field communications, light-based wireless communications, and/or other wireless communications.

Device 10 may be a handheld electronic device such as a cellular telephone, media player, gaming device, or other device, may be a laptop computer, tablet computer, or other portable computer, may be a desktop computer, may be a computer display, may be a display containing an embedded computer, may be a television or set top box, wireless base station, wireless access point, home entertainment console, portable speaker, gaming accessory, wristwatch device, head-mounted display device, or other wearable device, or may be other electronic equipment. Configurations in which device 10 has a rotatable lid as in a portable (e.g., laptop) computer are sometimes described herein as an example. This is, however, merely illustrative. Device 10 may be any suitable electronic equipment.

As shown in the example of FIG. 1, device 10 may have a housing such as housing 12. Housing 12 may be formed from plastic, metal (e.g., aluminum), fiber composites such as carbon fiber, glass, ceramic, other materials, and combinations of these materials. Housing 12 or parts of housing 12 may be formed using a unibody construction in which housing structures are formed from an integrated piece of material. Multipart housing constructions may also be used in which housing 12 or parts of housing 12 are formed from frame structures, housing walls, and other components that are attached to each other using fasteners, adhesive, and other attachment mechanisms.

As shown in FIG. 1, device 10 may have input-output devices such as track pad 18 (e.g., a touch pad, mouse, other touch-based user input device) and keyboard 16 (e.g., having a set of mechanical and/or electronic-based keys and/or a touch screen display). Device 10 may also have components such as cameras, microphones, speakers, buttons, status indicator lights, buzzers, sensors, and other input-output devices. These devices may be used to gather input for device 10 and may be used to supply a user of device 10 with output. Connector ports in device 10 may receive mating connectors (e.g., an audio plug, a connector associated with a data cable such as a Universal Serial Bus cable, a data cable that handles video and audio data such as a cable that connects device 10 to a computer display, television, or other monitor, etc.).

Device 10 may include a display such a display 14. Display 14 may be a liquid crystal display (LCD), a plasma display, an organic light-emitting diode (OLED) display, an electrophoretic display, or a display implemented using other display technologies. A touch sensor may be incorporated into display 14 (e.g., display 14 may be a touch screen display) or display 14 may be insensitive to touch. Touch sensors for display 14 may be resistive touch sensors, capacitive touch sensors, acoustic touch sensors, light-based touch sensors, force sensors, or touch sensors implemented using other touch technologies.

Device 10 may have a one-piece housing or a multi-piece housing. As shown in FIG. 1, for example, electronic device 10 may be a device such as a portable computer or other device that has a two-part housing formed from an upper housing portion such as upper housing 12A and a lower housing portion such as lower housing 12B. Upper housing 12A may include display 14 and may sometimes be referred to as a display housing or lid. Lower housing 12B may sometimes be referred to as a base housing or main housing.

Housings 12A and 12B may be connected to each other using hinge structures located along the upper edge of lower housing 12B and the lower edge of upper housing 12A. For example, housings 12A and 12B may be coupled by hinges 26 such as hinges 26A and 26B that are located at opposing left and right sides of housing 12 along a rotational axis such as axis 22 (sometimes referred to herein as hinge axis 22). A slot-shaped opening such as opening 20 may be formed between upper housing 12A and lower housing 12B and may be bordered on either end by hinges 26A and 26B.

Opening 20 is sometimes also referred to herein as gap 20 or slot 20 between upper housing 12A and lower housing 12B. Hinges 26A and 26B, which may be formed from conductive structures such as metal structures, may allow upper housing 12A to rotate about axis 22 in directions 24 relative to lower housing 12B. Slot 20 extends along the rear edge of lower housing 12B parallel to axis 22. The lateral plane of upper housing (lid) 12A and the lateral plane of lower housing 12B may be separated by a lid angle that varies between 0° when the lid is closed to 90°, 140°, 160°, 180° or more when the lid is fully opened. In other words, upper housing 12A may be oriented at a corresponding lid position (angle) relative to lower housing 12B. The lid position may be changed over time as upper housing 12A is rotated relative to lower housing 12B (e.g., between a fully open position and a closed position).

Each lid position of upper housing 12A may be characterized by a corresponding lid angle (e.g., the angle between the lateral plane of upper housing (lid) 12A and the lateral plane of lower housing 12B). Device 10 may include a lid position sensor in lower housing 12B and/or upper housing 12A that senses (e.g., measures, detects, identifies, etc.) the lid position (e.g., lid angle) of upper housing 12A relative to lower housing 12B. Control circuitry in device 10 may perform one or more actions based on the sensed lid position (e.g., to turn display 14 on or off, to adjust the brightness of display 14, to adjust one or more antennas in device 10, to wake device 10, to put device 10 into a sleep or idle mode, to power device 10 on or off, to exit, halt, or pause one or more software programs running on device 10, etc.).

Some of the structures in housing 12 may be conductive. For example, upper housing 12A and lower housing 12B may include conductive housing structures such as metal housing walls. Lower housing 12B may, for example, include an upper conductive housing wall 15 that defines the lateral plane of lower housing 12B that faces upper housing 12A. Keyboard 16 and trackpad 18 may be disposed at upper conductive housing wall 15 (e.g., may be mounted to upper conductive housing wall 15 and/or may be aligned with openings in upper conductive housing wall 15). Lower housing 12B may also include a lower conductive housing wall 23 opposite upper conductive housing wall 15. Lower conductive housing wall 23 may lie in a plane parallel to upper conductive housing wall 15. Lower housing 12B may have an interior cavity between upper conductive housing wall 15 and lower conductive housing wall 23.

If desired, lower housing 12B may include a clutch barrel along hinge axis 22 such as clutch barrel 28. Clutch barrel 28 may extend outwards from metal housing walls of lower housing 12B towards upper housing 12A (e.g., within slot 20). When upper housing 12A is attached to lower housing 12B, hinges 26A and 26B may be affixed to opposing ends of clutch barrel 28 (e.g., clutch barrel 28 may be laterally opposed to hinges 26A and 26B). Clutch barrel 28 may include springs and/or other clutch mechanisms that allow hinges 26A and 26B and thus upper housing 12A to rotate relative to lower housing 12B about hinge axis 22, while also mechanically holding upper housing 12A in place at a desired angle or orientation relative to lower housing 12B (e.g., intermediate angles between a fully open position and a closed position of upper housing 12A). Clutch barrel 28 may have walls that are formed from dielectric material and/or metal materials. In other implementations, clutch barrel 28 may be omitted and hinges 26 may be coupled to corresponding hinge structures on lower housing 12B without clutch barrel 28. If desired, the lid position sensor of device 10 may be disposed at least partially on or within clutch barrel 28, at least partially on or within lower housing 12B, and/or at least partially on or within upper housing 12A.

Upper housing 12A may be rotatable to a set of different lid positions about hinge axis 22 between a fully open position (as shown in FIG. 1) and a closed position. In the closed position, the lateral surface of display 14 and upper housing 12A faces and overlaps the lateral surface of lower housing 12B (e.g., upper conductive housing wall 15). When in the closed position, the peripheral housing walls of upper housing 12A (e.g., surrounding the lateral periphery of display 14) may lie flush with the peripheral housing walls of lower housing 12B (e.g., surrounding the lateral periphery of keyboard 16). This can make it difficult for a user to be able to provide suitable torque to upper housing 12A to move (open) upper housing 12A from the closed position to the fully open position.

As such, device 10 may include one or more finger-receiving recesses in the housing walls of lower housing 12B and/or upper housing 12A, such as finger scoop 23 in lower housing 12B. Finger scoop 23 may include a recessed, indented, notched, or angled portion of one or more housing walls of lower housing 12B (e.g., a recess, indentation, notch, or cavity in the one or more housing walls) that allows a force to be applied to upper housing 12A (e.g., a torque about hinge axis 22) that opens upper housing 12A from the closed position. In other words, finger scoop 23 may receive a user's finger or any other source of torque, allowing the user to open upper housing 12A. Finger scoop 23 is sometimes also referred to herein as finger recess 23, finger-receiving recess 23, recess 23, scoop 23, notch 23, indentation 23, cavity 23, finger-receiving notch 23, finger-receiving indentation 23, or finger-receiving cavity 23.

In general, lower housing 12B may include any desired number of finger scoops 23 along any desired edges of the lower housing. For example, lower housing 12B may include a finger scoop 23 along a user-facing edge (side) 25 of lower housing 12B (opposite upper housing 12A) or along one or more edges (sides) 17 (e.g., a left edge 17L and a right edge 17R of lower housing 12B) extending from user-facing edge 25 to upper housing 12A (e.g., at locations 19). Additionally or alternatively, upper housing 12A may include one or more finger scoops 23 along one or more of edges 25 and/or 17. In one implementation that is described herein as an example, finger scoop 23 is disposed on lower housing 12B at the center of user-facing edge 25 (e.g., overlapping a central axis of lower housing 12B parallel to the X-axis).

To ensure that antenna structures in device 10 function properly, care should be taken when placing the antenna structures relative to the conductive portions of housing 12. In implementations where upper housing 12A and lower housing 12B include metal housing walls, if care is not taken, the metal in the metal housing walls can block the antennas from conveying radio-frequency signals with free space in one or more positions of upper housing 12A relative to lower housing 12B. Care should also be taken to ensure that the user's body does not block or detune the antenna while the user interacts with device 10. To mitigate these issues and optimize antenna performance, device 10 may include one or more antennas formed from, disposed within, and/or overlapping finger scoop 23, for example.

Disposing the antenna(s) at finger scoop 23 may also serve to minimize the chance that a user's hands/arms 21 will block the antenna while interacting with device 10, because hands/arms 21 will most often extend around either side of finger scoop 23 while the user interacts with track pad 18 and/or keyboard 16. Additionally or alternatively, one or more antennas may be disposed within finger scoops at locations 19, within clutch barrel 28, within the interior cavity of lower housing 12B for radiating through one or more slots in the rear end of lower housing 12B facing upper housing 12A, aligned with one or more apertures in upper conductive housing wall 15 (e.g., around the periphery of keyboard 16), and/or elsewhere in device 10 subject to minimal blocking from hands/arms 21.

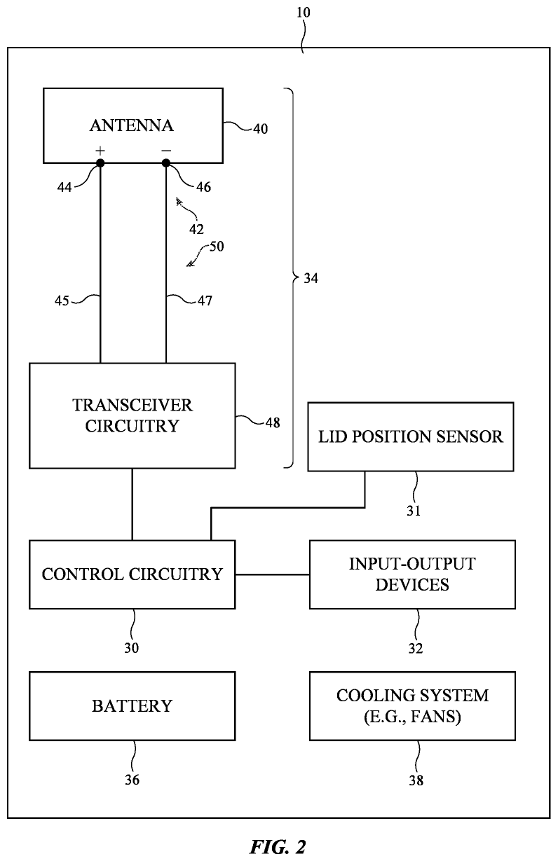

A schematic diagram showing illustrative components that may be used in device 10 is shown in FIG. 2. As shown in FIG. 2, device 10 may include control circuitry such as control circuitry 30. Control circuitry 30 may include storage and/or processing circuitry. Storage in control circuitry 30 may include hard disk drive storage, nonvolatile memory (e.g., flash memory or other electrically-programmable-read-only memory configured to form a solid-state drive), volatile memory (e.g., static or dynamic random-access-memory), etc. Processing circuitry in control circuitry 30 may be used to control the operation of device 10. This processing circuitry may include one or more processors such as microprocessors, microcontrollers, digital signal processors, host processors, baseband processor integrated circuits, application specific integrated circuits, central processing units (CPUs), graphics processing units (GPUs), etc. Control circuitry 30 may be configured to perform operations in device 10 using hardware (e.g., dedicated hardware or circuitry), firmware, and/or software. Software code for performing operations in device 10 may be stored on control circuitry 30 (e.g., storage in control circuitry 30 may include non-transitory (tangible) computer readable storage media that stores the software code). The software code may sometimes be referred to as program instructions, software, data, instructions, or code. Software code stored on the storage may be executed by processing circuitry in control circuitry 30.

Control circuitry 30 may be used to run software on device 10 such as internet browsing applications, voice-over-internet-protocol (VOIP) telephone call applications, email applications, media playback applications, operating system functions, etc. To support interactions with external equipment, control circuitry 30 may be used in implementing communications protocols. Communications protocols that may be implemented using control circuitry 30 include internet protocols, wireless local area network protocols (e.g., IEEE 802.11 protocols-sometimes referred to as WiFi®), protocols for other short-range wireless communications links such as the Bluetooth® protocol or other WPAN protocols, IEEE 802.11ad protocols, cellular telephone protocols (e.g., 3GPP 4th generation (4G) protocols, 3GPP 5th generation (5G) New Radio (NR) protocols such as an NR Frequency Range 1 (FR1) protocol and/or an NR Frequency Range 2 (FR2) protocol, 6th generation (6G) protocols, etc.), MIMO protocols, antenna diversity protocols, satellite navigation system protocols, antenna-based spatial ranging protocols (e.g., radio detection and ranging (RADAR) protocols or other desired range detection protocols for signals conveyed at millimeter and centimeter wave frequencies), etc. Each communication protocol may be associated with a corresponding radio access technology (RAT) that specifies the physical connection methodology used in implementing the protocol.

Device 10 may include input-output devices 32. Input-output devices 32 may be used to allow data to be supplied to device 10 and to allow data to be provided from device 10 to external devices. Input-output devices 32 may include user interface devices, data port devices, and other input-output components. For example, input-output devices may include touch screens, displays without touch sensor capabilities, buttons, joysticks, scrolling wheels, touch pads, key pads, keyboards, microphones, cameras, speakers, status indicators, light sources, audio jacks and other audio port components, digital data port devices, light sensors, accelerometers, proximity sensors, and other sensors and input-output components.

Device 10 may also include a lid position sensor such as lid position sensor 31 (sometimes also referred to herein as lid orientation sensor 31 or lid angle sensor 31). Lid position sensor 31 may sense, detect, measure, or otherwise identify the lid position (angle) of upper housing 12A relative to lower housing 12B (FIG. 1). The lid position may be one of a set of possible lid positions between a fully open position and a closed position. Lid positions that are not the closed position are sometimes also referred to herein as open positions. Lid position sensor 31 may include one or more electrical sensors, one or more mechanical sensors, one or more optical sensors (e.g., optical emitters and/or receivers), one or more electromechanical sensors, and/or any other type of sensor that detects the angle or position of upper housing 12A relative to lower housing 12B. Lid position sensor 31 may include, for example, one or more capacitive sensors (e.g., that measure lid position based on a capacitance between a first electrode in upper housing 12A and a second electrode in lower housing 12B, where the capacitance varies based on lid position), resistive sensors, piezoelectric sensors, proximity sensors, hinge sensors, microelectromechanical systems (MEMS) sensors, orientation sensors (e.g., an inertial measurement unit (IMU), gyroscope, accelerometer, compass, etc.), optical sensors (e.g., infrared sensors, ambient light sensors, image sensors, etc.), and/or any other desired lid position sensors. Lid position sensor 31 may transmit information identifying the detected position of upper housing 12A to control circuitry 30 for further processing (e.g., for adjusting one or more antennas in device 10).

Device 10 may include wireless communications circuitry 34 that allows control circuitry 30 of device 10 to communicate wirelessly with external equipment. The external equipment with which device 10 communicates wirelessly may be a computer, a cellular telephone, a watch, a router, access point, or other wireless local area network equipment, a wireless base station in a cellular telephone network, a display, a head-mounted device, or other electronic equipment. Wireless communications circuitry 34 may include radio-frequency (RF) transceiver circuitry 48 and one or more antennas such as antenna 40. Configurations in which device 10 contains a single antenna may sometimes be described herein as an example. In general, device 10 may include any number of antennas.

Transceiver circuitry 48 may support communications in millimeter wave communications bands between about 30 GHz and 300 GHz and/or centimeter wave communications bands between about 10 GHz and 30 GHz (e.g., Extremely High Frequency (EHF) bands, Super High Frequency (SHF) bands, IEEE K communications band between about 18 GHz and 27 GHz, a Kₐ communications band between about 26.5 GHz and 40 GHz, a Ku communications band between about 12 GHz and 18 GHz, a V communications band between about 40 GHz and 75 GHz, a W communications band between about 75 GHz and 110 GHz, or any other desired frequency band between approximately 10 GHz and 300 GHz, IEEE 802.11ad communications at 60 GHz such as WiGig or 60 GHz Wi-Fi bands around 57-61 GHz, 5th generation mobile networks or 5th generation wireless systems (5G) NR FR2 communications bands between about 24 GHz and 90 GHz, etc.), wireless local area network (WLAN) communications bands such as the 2.4 GHz and 5 GHz Wi-Fi® (IEEE 802.11) bands, wireless personal area network (WPAN) communications bands such as the 2.4 GHz Bluetooth® communications band, cellular telephone communications bands such as a cellular low band (LB) (e.g., 600 to 960 MHz), a cellular low-midband (LMB) (e.g., 1400 to 1550 MHz), a cellular midband (MB) (e.g., from 1700 to 2200 MHz), a cellular high band (HB) (e.g., from 2300 to 2700 MHZ), a cellular ultra-high band (UHB) (e.g., from 3300 to 5000 MHz, or other cellular communications bands between about 600 MHz and about 10 THz (e.g., 3G bands, 4G LTE bands, 5G New Radio (NR) Frequency Range 1 (FR1) bands below 10 GHz, 5G NR FR2 bands between around 10 GHz and 100 GHz, sub-THz, THz, or THF bands between around 100 GHz and 10 THz such as 6G bands, etc.), a near-field communications (NFC) band (e.g., at 13.56 MHz), satellite navigations bands (e.g., an L1 global positioning system (GPS) band at 1575 MHz, an L5 GPS band at 1176 MHz, a Global Navigation Satellite System (GLONASS) band, a BeiDou Navigation Satellite System (BDS) band, etc.), ultra-wideband (UWB) communications band(s) supported by the IEEE 802.15.4 protocol and/or other UWB communications protocols (e.g., a first UWB communications band at 6.5 GHz and/or a second UWB communications band at 8.0 GHz), and/or any other desired communications bands. The communications bands handled by the radio-frequency transceiver circuitry may sometimes be referred to herein as frequency bands or simply as “bands,” and may span corresponding ranges of frequencies. Transceiver circuitry 48 may include one or more integrated circuits, power amplifier circuitry, low-noise input amplifiers, passive radio-frequency components, switching circuitry, transmission line structures, and other circuitry for handling radio-frequency signals.

If desired, transceiver circuitry 48 may perform spatial ranging operations using radio-frequency signals at millimeter and/or centimeter wave frequencies that are transmitted and received by transceiver circuitry 48. The received signals may be a version of the transmitted signals that have been reflected off of external objects and back towards device 10. Control circuitry 30 may process the transmitted and received signals to detect or estimate a range between device 10 and one or more external objects in the surroundings of device 10 (e.g., objects external to device 10 such as the body of a user or other persons, other devices, animals, furniture, walls, or other objects or obstacles in the vicinity of device 10). If desired, control circuitry 30 may also process the transmitted and received signals to identify a two or three-dimensional spatial location of the external objects relative to device 10.

Spatial ranging operations performed by transceiver circuitry 48 are unidirectional. If desired, transceiver circuitry 48 may also perform bidirectional communications with external wireless equipment over a bi-directional communications link (e.g., a millimeter/centimeter wave wireless communications link). The external wireless equipment may include other electronic devices such as device 10, a wireless base station, wireless access point, a wireless accessory, or any other desired equipment that transmits and receives millimeter/centimeter wave signals. Bidirectional communications involve both the transmission of wireless data by transceiver circuitry 48 and the reception of wireless data that has been transmitted by external wireless equipment. The wireless data may, for example, include data that has been encoded into corresponding data packets such as wireless data associated with a telephone call, streaming media content, internet browsing, wireless data associated with software applications running on device 10, email messages, etc. Conveying radio-frequency signals at relatively high frequencies (e.g., greater than or equal to 10 GHz) can greatly increase the overall data throughput of transceiver circuitry 48. However, signals at these frequencies are subject to substantial over-the-air signal attenuation. To mitigate these issues, antennas 40 that handle these frequencies may be arranged in one or more phased antenna arrays if desired.

If desired, device 10 may be supplied with a battery such as battery 36. Control circuitry 30, input-output devices 32, wireless communications circuitry 34, and power management circuitry associated with battery 36 may produce heat during operation. To ensure that these components are cooled satisfactorily, device 10 may be provided with a cooling system such as cooling system 38. Cooling system 38, which may sometimes be referred to as a ventilation system, may include one or more fans and other equipment for removing heat from the components of device 10. Cooling system 38 may include structures that form airflow ports (e.g., openings in ventilation port structures located along slot 20 of FIG. 1 or other portions of device 10 through which cool air may be drawn by one or more cooling fans and through which air that has been warmed from heat produced by internal components may be expelled). Airflow ports, which may sometimes be referred to as cooling ports, ventilation ports, air exhaust and entrance ports, etc., may be formed from arrays of openings in plastic ventilation port structures or other structures associated with cooling system 38.

Transceiver circuitry 48 may convey radio-frequency signals using one or more antennas 40 (e.g., antennas 40 may convey the radio-frequency signals for the transceiver circuitry). The term “convey radio-frequency signals” as used herein means the transmission and/or reception of the radio-frequency signals (e.g., for performing unidirectional and/or bidirectional wireless communications with external wireless communications equipment). Antennas 40 may transmit the radio-frequency signals by radiating the radio-frequency signals into free space (or to free space through intervening device structures such as a dielectric cover layer). Antennas 40 may additionally or alternatively receive the radio-frequency signals from free space (e.g., through intervening devices structures such as a dielectric cover layer). The transmission and reception of radio-frequency signals by antennas 40 each involve the excitation or resonance of antenna currents on an antenna resonating element in the antenna by the radio-frequency signals within the frequency band(s) of operation of the antenna.

Antennas 40 in wireless circuitry 34 may be formed using any suitable antenna structures. For example, antennas 40 may include antennas with resonating elements that are formed from stacked patch antenna structures, loop antenna structures, patch antenna structures, inverted-F antenna structures, slot antenna structures, planar inverted-F antenna structures, monopole antenna structures, dipole antenna structures, helical antenna structures, Yagi (Yagi-Uda) antenna structures, dielectric resonator antennas, hybrids of these designs, etc. If desired, one or more of antennas 40 may be cavity-backed antennas. Different types of antennas may be used for different bands and combinations of bands. If desired, antennas 40 may be arranged in one or more phased antenna arrays.

As shown in FIG. 2, transceiver circuitry 48 in wireless communications circuitry 34 may be coupled to antennas such as antenna 40 using radio-frequency transmission line paths such as transmission line 50. Transmission line paths in device 10 such as transmission line 50 may include coaxial cables, microstrip transmission lines, stripline transmission lines, edge-coupled microstrip transmission lines, edge-coupled stripline transmission lines, waveguide transmission lines (e.g., coplanar waveguides, grounded coplanar waveguides, etc.), transmission lines formed from combinations of transmission lines of these types, etc.

Transmission line paths in device 10 such as transmission line 50 may be integrated into rigid and/or flexible printed circuit boards if desired. In one suitable arrangement, transmission line paths in device 10 may include transmission line conductors (e.g., signal and/or ground conductors) that are integrated within multilayer laminated structures (e.g., layers of a conductive material such as copper and a dielectric material such as a resin that are laminated together without intervening adhesive) that may be folded or bent in multiple dimensions (e.g., two or three dimensions) and that maintain a bent or folded shape after bending (e.g., the multilayer laminated structures may be folded into a particular three-dimensional shape to route around other device components and may be rigid enough to hold its shape after folding without being held in place by stiffeners or other structures). All of the multiple layers of the laminated structures may be batch laminated together (e.g., in a single pressing process) without adhesive (e.g., as opposed to performing multiple pressing processes to laminate multiple layers together with adhesive). Filter circuitry, switching circuitry, impedance matching circuitry, and other circuitry may be interposed within the transmission lines, if desired.

Transmission line 50 in device 10 may be coupled to antenna feed 42 of antenna 40. Antenna 40 of FIG. 2 may, for example, form a patch antenna, an inverted-F antenna, a planar inverted-F antenna, a slot antenna, a hybrid inverted-F slot antenna or other antenna having an antenna feed such as antenna feed 42 with a positive antenna feed terminal such as positive antenna feed terminal 44 and a ground antenna feed terminal such as ground antenna feed terminal 46. Transmission line 50 may include a positive transmission line conductor 45 (sometimes referred to herein as signal conductor 45) and a ground transmission line conductor 47 (sometimes referred to herein as ground conductor 47). Signal conductor 45 may be coupled to positive antenna feed terminal 44 and ground conductor 47 may be coupled to ground antenna feed terminal 46. Other types of antenna feed arrangements may be used (e.g., indirect feed arrangements, feed arrangements in which antenna 40 is fed using multiple feeds, etc.) and multiple antennas 40 may be provided in device 10, if desired. The feeding configuration of FIG. 2 is merely illustrative.

Filter circuitry, switching circuitry, impedance matching circuitry, and other circuitry may be interposed within transmission line 50, in or between parts of antenna 40, or in other portions of wireless communications circuitry 34, if desired. Control circuitry 30 may be coupled to transceiver circuitry 48 and input-output devices 32. During operation, input-output devices 32 may supply output from device 10 and may receive input from sources that are external to device 10. Control circuitry 30 may use wireless communications circuitry 34 to transmit and receive wireless signals.

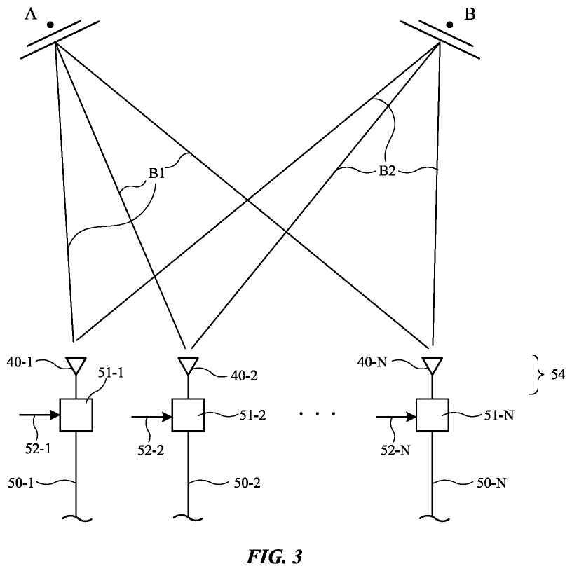

To help boost the gain of antennas 40 (e.g., when operating at frequencies subject to substantial path loss such as millimeter and centimeter wave frequencies), multiple antennas 40 may be integrated into a phased antenna array. FIG. 3 shows how antennas 40 for handling radio-frequency signals at millimeter and centimeter wave frequencies may be formed in a phased antenna array. As shown in FIG. 3, phased antenna array 54 (sometimes referred to herein as array 54, antenna array 54, or array 54 of antennas 40) may be coupled to radio-frequency transmission lines 50. For example, a first antenna 40-1 in phased antenna array 54 may be coupled to a first radio-frequency transmission line 50-1, a second antenna 40-2 in phased antenna array 54 may be coupled to a second radio-frequency transmission line 50-2, an Nth antenna 40-N in phased antenna array 54 may be coupled to an Nth radio-frequency transmission line 50-N, etc. While antennas 40 are described herein as forming a phased antenna array, the antennas 40 in phased antenna array 54 may sometimes also be referred to as collectively forming a single phased array antenna (e.g., where antennas 40 form antenna elements or radiators of the phased array antenna).

Antennas 40 in phased antenna array 54 may be arranged in any desired number of rows and columns or in any other desired pattern (e.g., the antennas need not be arranged in a grid pattern having rows and columns). In some implementations that are described herein as an example, the N antennas in phased antenna array 54 are aligned along a single linear axis (e.g., are co-linear with each other in a single row or column). N may be any desired integer greater than one (e.g., two, three, four, eight, more than four, more than eight, etc.). In general, higher values of N increases the peak gain achievable by the phased antenna array.

During signal transmission operations, radio-frequency transmission lines 50 may be used to supply signals (e.g., radio-frequency signals such as millimeter wave and/or centimeter wave signals) from millimeter/centimeter wave transceiver circuitry 48 (FIG. 2) to phased antenna array 54 for wireless transmission. During signal reception operations, radio-frequency transmission lines 50 may be used to supply signals received at phased antenna array 54 (e.g., from external wireless equipment or transmitted signals that have been reflected off of external objects) to millimeter/centimeter wave transceiver circuitry 48 (FIG. 3).

The antennas 40 in phased antenna array 54 may be separated or spaced apart from one or more adjacent antennas in the array by a fixed (phased) distance (e.g., approximately half the wavelength of operation) to allow for the array to perform beam forming. Beam forming (steering) may be performed by controlling the relative phases and/or magnitudes (amplitudes) of the radio-frequency signals conveyed by the antennas 40 in phased antenna array 54. In the example of FIG. 3, antennas 40 each have a corresponding radio-frequency phase and magnitude controller 51 (e.g., a first phase and magnitude controller 51-1 disposed on radio-frequency transmission line 50-1 may control phase and magnitude for radio-frequency signals handled by antenna 40-1, a second phase and magnitude controller 51-2 disposed on radio-frequency transmission line 50-2 may control phase and magnitude for radio-frequency signals handled by antenna 40-2, an Nth phase and magnitude controller 51-N disposed on radio-frequency transmission line 50-N may control phase and magnitude for radio-frequency signals handled by antenna 40-N, etc.).

Phase and magnitude controllers 51 may each include circuitry for adjusting the phase of the radio-frequency signals on radio-frequency transmission lines 50 (e.g., phase shifter circuits) and/or circuitry for adjusting the magnitude of the radio-frequency signals on radio-frequency transmission lines 50 (e.g., power amplifier and/or low noise amplifier circuits). Phase and magnitude controllers 51 may sometimes be referred to collectively herein as beam steering circuitry (e.g., beam steering circuitry that steers the beam of radio-frequency signals transmitted and/or received by phased antenna array 54).

Phase and magnitude controllers 51 may adjust the relative phases and/or magnitudes of the transmitted signals that are provided to each of the antennas in phased antenna array 54 and may adjust the relative phases and/or magnitudes of the received signals that are received by phased antenna array 54. Phase and magnitude controllers 51 may, if desired, include phase detection circuitry for detecting the phases of the received signals that are received by phased antenna array 54. The term “beam” or “signal beam” may be used herein to collectively refer to wireless signals that are transmitted and received by phased antenna array 54 in a particular direction. The signal beam may exhibit a peak gain that is oriented in a particular pointing direction at a corresponding pointing angle (e.g., based on constructive and destructive interference from the combination of signals from each antenna in the phased antenna array). The term “transmit beam” may sometimes be used herein to refer to radio-frequency signals that are transmitted in a particular direction whereas the term “receive beam” may sometimes be used herein to refer to radio-frequency signals that are received from a particular direction. The receive beam may correspond to a set of phase and magnitude settings that cause signals received across the phased antenna array to coherently add or combine together at the output of the phased antenna array.

If, for example, phase and magnitude controllers 51 are adjusted to produce a first set of phases and/or magnitudes for transmitted radio-frequency signals, the transmitted signals will form a transmit beam as shown by beam B1 of FIG. 3 that is oriented in the direction of point A. If, however, phase and magnitude controllers 51 are adjusted to produce a second set of phases and/or magnitudes for the transmitted signals, the transmitted signals will form a transmit beam as shown by beam B2 that is oriented in the direction of point B. Similarly, if phase and magnitude controllers 51 are adjusted to produce the first set of phases and/or magnitudes, radio-frequency signals (e.g., radio-frequency signals in a receive beam) may be received from the direction of point A, as shown by beam B1. If phase and magnitude controllers 51 are adjusted to produce the second set of phases and/or magnitudes, radio-frequency signals may be received from the direction of point B, as shown by beam B2.

Each phase and magnitude controller 51 may be controlled to produce a desired phase and/or magnitude based on a corresponding control signal 52 received from control circuitry 30 of FIG. 2 (e.g., the phase and/or magnitude provided by phase and magnitude controller 51-1 may be controlled using control signal 52-1, the phase and/or magnitude provided by phase and magnitude controller 51-2 may be controlled using control signal 52-2, etc.). If desired, the control circuitry may actively adjust control signals 52 in real time to steer the transmit or receive beam in different desired directions over time.

Phased antenna array 54 may have a set of formable signal beams. Each signal beam may correspond to different respective phase and magnitude settings for phase and magnitude controllers 51. Device 10 may store a codebook that maps each of the signal beams in the set of formable signal beams to its respective phase and magnitude settings, beam pointing angle, and/or value of control signals 52 (e.g., beamforming coefficients/weights).

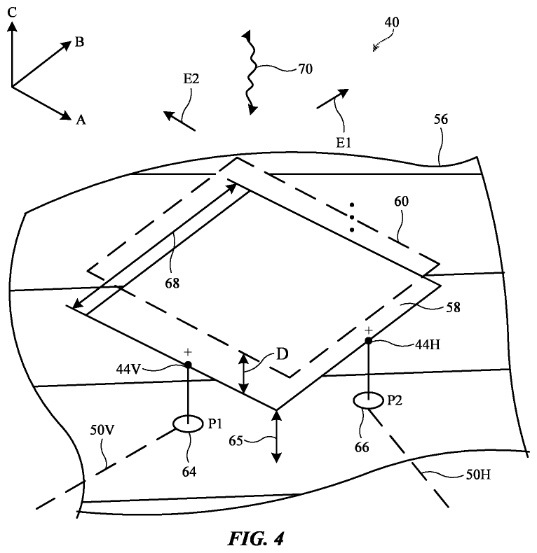

When performing wireless communications using radio-frequency signals at millimeter wave, centimeter wave, or higher frequencies, the radio-frequency signals are conveyed over a line of sight path between phased antenna array 54 and external communications equipment. If the external object is located at point A of FIG. 4, phase and magnitude controllers 51 may be adjusted to steer the signal beam towards point A (e.g., to steer the pointing direction of the signal beam towards point A). Phased antenna array 54 may transmit and receive radio-frequency signals in the direction of point A. Similarly, if the external communications equipment is located at point B, phase and magnitude controllers 51 may be adjusted to steer the signal beam towards point B (e.g., to steer the pointing direction of the signal beam towards point B). Phased antenna array 54 may transmit and receive radio-frequency signals in the direction of point B. Beam steering may also be used to steer the signal beam to point away from external objects that may otherwise block or overlap the signal beam. This may help to maximize the overall throughput and efficiency of the wireless circuitry in communicating with external communications equipment.

In the example of FIG. 3, beam steering is shown as being performed over a single degree of freedom for the sake of simplicity (e.g., towards the left and right on the page of FIG. 4). This may, for example, correspond to implementations where the N antennas 40 in phased antenna array 54 are arranged in a linear pattern (e.g., as a uniform linear array (ULA) having uniformly or equally spaced antennas) along the same linear axis (e.g., in a single row or column). Since the antennas in a linear array cannot be phased to adjust the amount of constructive/destructive interference of conveyed radio-frequency signals along an axis orthogonal to the linear axis shared by the antennas, such arrays may perform beam forming and beam steering at angles along the linear axis shared by the antennas but not along the orthogonal axis. This example is illustrative and non-limiting. In general, the antennas in phased antenna arrays 54 may be arranged in a two-dimensional pattern to allow signal beam steering over two or more degrees of freedom (e.g., in two or three dimensions, into and out of the page and to the left and right on the page of FIG. 4). Phased antenna array 54 may have a corresponding field of view over which beam steering can be performed (e.g., in a hemisphere or a segment of a hemisphere over the phased antenna array). If desired, device 10 may include multiple phased antenna arrays that each face a different direction to provide coverage from multiple sides of the device.

Any desired antenna structures may be used for implementing antennas 40. In one suitable arrangement that is sometimes described herein as an example, patch antenna structures may be used for implementing antennas 40. Antennas 40 that are implemented using patch antenna structures may sometimes be referred to herein as patch antennas. An illustrative patch antenna that may be used in phased antenna array 54 of FIG. 3 is shown in FIG. 4.

As shown in FIG. 4, antenna 40 may have a patch antenna resonating element 58 that is separated from and parallel to a ground plane such as antenna ground 56. Patch antenna resonating element 58 may lie within a plane such as the A-B plane of FIG. 4 (e.g., the lateral surface area of element 58 may lie in the A-B plane). Patch antenna resonating element 58 may sometimes be referred to herein as patch 58, patch element 58, patch resonating element 58, antenna resonating element 58, or resonating element 58. Antenna ground 56 may lie within a plane that is parallel to the plane of patch element 58. Patch element 58 and antenna ground 56 may therefore lie in separate parallel planes that are separated by distance 65. Patch element 58 and antenna ground 56 may be formed from conductive traces patterned on a dielectric substrate such as a rigid or flexible printed circuit board substrate or any other desired conductive structures.

The length of the sides of patch element 58 may be selected so that antenna 40 resonates at a desired operating frequency. For example, the sides of patch element 58 may each have a length 68 that is approximately equal to half of the wavelength of the signals conveyed by antenna 40 (e.g., the effective wavelength given the dielectric properties of the materials surrounding patch element 58). In one suitable arrangement, length 68 may be between 0.8 mm and 1.2 mm (e.g., approximately 1.1 mm) for covering a millimeter wave frequency band between 57 GHz and 70 GHz or between 1.6 mm and 2.2 mm (e.g., approximately 1.85 mm) for covering a millimeter wave frequency band between 37 GHz and 41 GHz, as just two examples.

The example of FIG. 4 is merely illustrative. Patch element 58 may have a square shape in which all of the sides of patch element 58 are the same length or may have a different rectangular shape. Patch element 58 may be formed in other shapes having any desired number of straight and/or curved edges.

To enhance the polarizations handled by antenna 40, antenna 40 may be provided with multiple feeds. As shown in FIG. 4, antenna 40 may have a first feed at antenna port P1 that is coupled to a first radio-frequency transmission line 50 such as radio-frequency transmission line 50V. Antenna 40 may have a second feed at antenna port P2 that is coupled to a second radio-frequency transmission line 50 such as radio-frequency transmission line 50H. The first antenna feed may have a first ground feed terminal coupled to antenna ground 56 (not shown in FIG. 4 for the sake of clarity) and a first positive antenna feed terminal 44V coupled to patch element 58. The second antenna feed may have a second ground feed terminal coupled to antenna ground 56 (not shown in FIG. 4 for the sake of clarity) and a second positive antenna feed terminal 44H on patch element 58.

Holes or openings such as openings 64 and 66 may be formed in antenna ground 56. Radio-frequency transmission line 50V may include a vertical conductor (e.g., a conductive through-via, conductive pin, metal pillar, solder bump, feed probe, combinations of these, or other vertical conductive interconnect structures) that extends through opening 64 to positive antenna feed terminal 44V on patch element 58. Radio-frequency transmission line 50H may include a vertical conductor that extends through opening 66 to positive antenna feed terminal 44H on patch element 58. This example is merely illustrative and, if desired, other transmission line structures may be used (e.g., coaxial cable structures, stripline transmission line structures, etc.).

When using the first antenna feed associated with port P1, antenna 40 may transmit and/or receive radio-frequency signals having a first polarization (e.g., the electric field E1 of radio-frequency signals 70 associated with port P1 may be oriented parallel to the B-axis in FIG. 4). When using the antenna feed associated with port P2, antenna 40 may transmit and/or receive radio-frequency signals having a second polarization (e.g., the electric field E2 of radio-frequency signals 70 associated with port P2 may be oriented parallel to the A-axis of FIG. 4 so that the polarizations associated with ports P1 and P2 are orthogonal to each other).

One of ports P1 and P2 may be used at a given time so that antenna 40 operates as a single-polarization antenna or both ports may be operated at the same time so that antenna 40 operates with other polarizations (e.g., as a dual-polarization antenna, a circularly-polarized antenna, an elliptically-polarized antenna, etc.). If desired, the active port may be changed over time so that antenna 40 can switch between covering vertical or horizontal polarizations at a given time. Ports P1 and P2 may be coupled to different phase and magnitude controllers 51 (FIG. 3) or may both be coupled to the same phase and magnitude controller 51. If desired, ports P1 and P2 may both be operated with the same phase and magnitude at a given time (e.g., when antenna 40 acts as a dual-polarization antenna). If desired, the phases and magnitudes of radio-frequency signals conveyed over ports P1 and P2 may be controlled separately and varied over time so that antenna 40 exhibits other polarizations (e.g., circular or elliptical polarizations).

If care is not taken, antennas 40 such as dual-polarization patch antennas of the type shown in FIG. 4 may have insufficient bandwidth for covering relatively wide ranges of frequencies. It may be desirable for antenna 40 to be able to cover a first frequency band, a second frequency band at frequencies higher than the first frequency band, and a third frequency higher than the second frequency band. In one suitable arrangement that is described herein as an example, the first frequency band may include frequencies from about 24.5-29.5 GHz (sometimes referred to herein as a low band), the second frequency band may include frequencies from about 37-43.5 GHZ (sometimes referred to herein as a midband), and the third frequency band may include frequencies from about 47-48 GHz (sometimes referred to herein as a high band). In these scenarios, a single patch element 58 may not exhibit sufficient bandwidth on its own to cover an entirety of the first, second, and third frequency bands.

While only a single patch element 58 is shown in FIG. 4 for the sake of clarity, antenna 40 may include multiple patch elements 58 that are vertically stacked and overlapping each other (e.g., along the +C direction). Each patch element 58 may be directly fed using respective antenna feeds and may be coupled to one or two corresponding positive antenna feed terminals 62. Each patch element 58 may have different dimensions or a different size to cover different frequency bands for antenna 40. Additionally or alternatively, antenna 40 may include one or more additional patch elements 60 that are stacked over one or more patch elements 58.

Patch element 60 is unfed (e.g., there are no antenna feed terminals on patch elements 60). As such, patch element 60 is a parasitic patch. Patch element 60 may therefore sometimes be referred to herein as parasitic patch element 60, parasitic patch 60, or parasitic 60. Parasitic patch 60 may partially or completely overlap an underlying patch element 58. If desired, multiple stacked parasitic patches 60 may be provided over an underlying patch element 58 and may be excited by the underlying patch element 58. A lower-most parasitic patch 60 may be separated from a corresponding patch element 58 by distance D, which is selected to provide antenna 40 with a desired bandwidth without occupying excessive volume within device 10. Parasitic patch 60 may be indirectly fed or excited by the underlying directly fed patch element 58. Parasitic patch 60 may have sides with lengths other than length 68, which configure the parasitic patch to radiate at different frequencies than the underlying patch element 58, thereby extending the overall bandwidth of antenna 40.

The combined resonances of each patch element 58 and each parasitic patch 60 in antenna 40 may configure antenna 40 to radiate with satisfactory antenna efficiency across an entirety of the first, second, and third frequency bands (e.g., from 24.5-29.5 GHZ, from 37-43.5 GHz, and from 47-48 GHz, or other bands). The example of FIG. 4 is merely illustrative. Parasitic patches 60 may be omitted if desired. Parasitic patches 60 may be rectangular, square, cross-shaped, or any other desired shape having any desired number of straight and/or curved edges. Parasitic patch 60 may be provided at any desired orientation relative to its underlying patch element 58. Antenna 40 may have any desired number of feeds. Other antenna types may be used if desired (e.g., dipole antennas, monopole antennas, slot antennas, etc.).

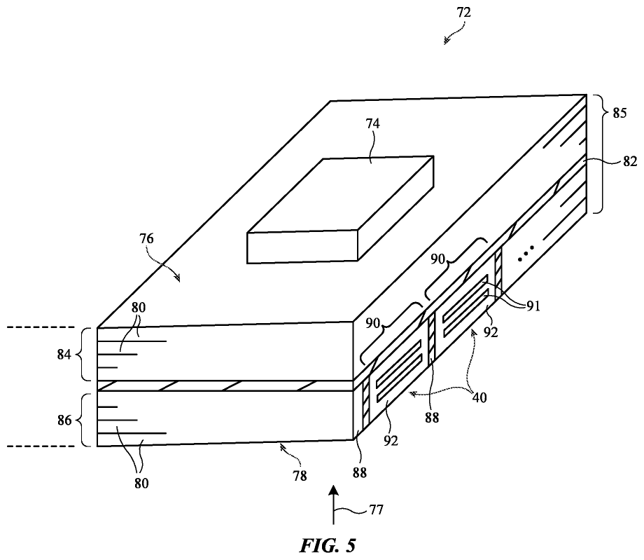

If desired, phased antenna array 54 may be integrated with other circuitry such as a radio-frequency integrated circuit to form an integrated antenna module. FIG. 5 is a rear perspective view showing one example of integrated antenna module for handling signals at frequencies greater than 10 GHz in device 10. As shown in FIG. 5, device 10 may be provided with an integrated antenna module such as integrated antenna module 72 (sometimes referred to herein as antenna module 72, antenna panel 72, or module 72).

Antenna module 72 may include phased antenna array 54 of antennas 40 formed on a dielectric substrate such as substrate 85. Substrate 85 may be, for example, a rigid printed circuit board, a flexible printed circuit board, a plastic substrate (e.g., a molded substrate), a polymer substrate, an interposer (e.g., a glass or silicon interposer), a semiconductor substrate (e.g., a silicon integrated circuit chip), or another type of substrate. If desired, substrate 85 may be a stacked dielectric substrate that includes multiple stacked dielectric (insulator) layers 80 (e.g., multiple layers of printed circuit board substrate such as multiple layers of fiberglass-filled epoxy, polymer, silicon or other semiconductors, rigid printed circuit board material, ceramic, polyimide, flexible printed circuit board material, plastic, glass, or other dielectrics). Phased antenna array 54 may include any desired number of antennas 40 arranged in any desired pattern.

Antennas 40 in phased antenna array 54 may include antenna elements such as patch elements 91 (e.g., patch elements 91 may form patch element 58 and/or one or more parasitic patches 60 of FIG. 4). Patch elements 91 may be formed from one or more metallization layers of substrate 85. Ground layer 82 may be formed from one or more metallization layers of substrate 85 (e.g., may include conductive traces forming antenna ground 56 of FIG. 4 for each of the antennas 40 in phased antenna array 54). Patch elements 91 may be patterned on (bottom) surface 78 of substrate 85 or may be embedded within dielectric layers 80 at or adjacent to surface 78. Only two patch elements 91 are shown in FIG. 5 for the sake of clarity. This is merely illustrative and, in general, antennas 40 may include any desired number of patch elements 91.

One or more electrical components 74 may be mounted on (top) surface 76 of substrate 85 (e.g., the surface of substrate 85 opposite surface 78 and patch elements 91). Component 74 may, for example, include an integrated circuit (e.g., an integrated circuit chip) or other circuitry mounted to surface 76 of substrate 85. Component 74 may include radio-frequency components such as amplifier circuitry, phase shifter circuitry (e.g., phase and magnitude controllers 51 of FIG. 3), and/or other circuitry that operates on radio-frequency signals. Component 74 may sometimes be referred to herein as radio-frequency integrated circuit (RFIC) 74. However, this is merely illustrative and, in general, the circuitry of RFIC 74 need not be formed on an integrated circuit. Component 74 may be embedded within a plastic overmold if desired.

The dielectric layers 80 in substrate 85 may include a first set of layers 86 (sometimes referred to herein as antenna layers 86) and a second set of layers 84 (sometimes referred to herein as transmission line layers 84). Ground layer 82 may separate antenna layers 86 from transmission line layers 84. Conductive traces or other metal layers on transmission line layers 84 may be used in forming transmission line structures such as radio-frequency transmission lines 50 of FIG. 3 (e.g., radio-frequency transmission lines 50V and 50H of FIG. 4). For example, conductive traces on transmission line layers 84 may be used in forming stripline or microstrip transmission lines that are coupled between the antenna feeds for antennas 40 (e.g., over conductive vias extending through antenna layers 86) and RFIC 74 (e.g., over conductive vias extending through transmission line layers 84). A board-to-board connector (not shown) may couple RFIC 74 to the baseband and/or transceiver circuitry for phased antenna array 54 (e.g., transceiver circuitry 48 of FIG. 2).

If desired, each antenna 40 in phased antenna array 54 may be laterally surrounded by fences of conductive vias 88 (e.g., conductive vias extending parallel to the X-axis and through antenna layers 86 of FIG. 5). The fences of conductive vias 88 for phased antenna array 54 may be shorted to ground traces 82 so that the fences of conductive vias 88 are held at a ground potential. Conductive vias 88 may extend downwards to surface 78 or to the same dielectric layer 80 as the bottom-most conductive patch 91 in phased antenna array 54.

The fences of conductive vias 88 may be opaque at the frequencies covered by antennas 40. Each antenna 40 may lie within a respective antenna cavity 92 having conductive cavity walls defined by a corresponding set of fences of conductive vias 88 in antenna layers 86. The fences of conductive vias 88 may help to ensure that each antenna 40 in phased antenna array 54 is suitably isolated, for example. Phased antenna array 54 may include a number of antenna unit cells 90. Each antenna unit cell 90 may include respective fences of conductive vias 88, a respective antenna cavity 92 defined by (e.g., laterally surrounded by) those fences of conductive vias, and a respective antenna 40 (e.g., set of patch elements 91) within that antenna cavity 92. Conductive vias 88 may be omitted if desired. Phased antenna array 54 need not be integrated into antenna module 72 and may in general include any types of antennas mounted to and/or embedded within any desired substrate.

Phased antenna array 54 (e.g., antenna module 72) may be disposed within lower housing 12B of device 10 (FIG. 1). Phased antenna array 54 may be aligned with an aperture in a conductive housing wall of lower housing 12B. This may allow the phased antenna array to be hidden within lower housing 12B (e.g., protecting the array from damage or contaminants) while allowing the phased antenna array to convey radio-frequency signals with external equipment, despite the presence of conductive housing structures in lower housing 12B, and with minimal impact from the user's body (e.g., hands/arms 21).

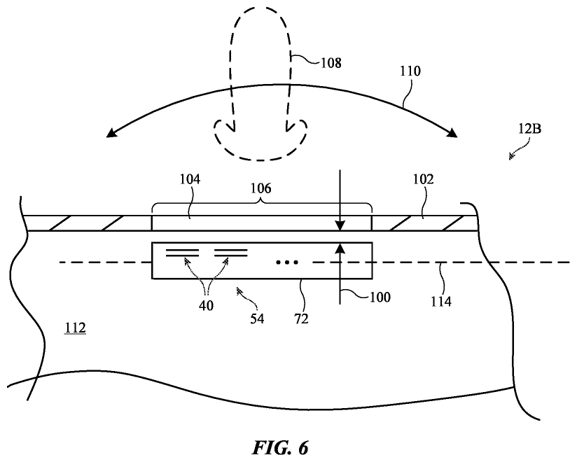

FIG. 6 is a cross-sectional side view showing how phased antenna array 54 may be aligned with an aperture in a conductive housing wall of lower housing 12B. As shown in FIG. 6, lower housing 12B may include a conductive housing wall 102. Conductive housing wall 102 may have a dielectric-filled opening such as aperture 106 (sometimes also referred to herein as slot 106).

A dielectric cover layer such as dielectric window 104 may be disposed within aperture 106 to protect the interior cavity 112 of lower housing 12B from dirt, moisture, or other contaminants. If desired, dielectric window 104 may be optically opaque, tinted, and/or provided with a masking layer to help hide interior cavity 112 from view. Dielectric window 104 may be formed from plastic, ceramic, polymer, sapphire, glass, and/or other solid dielectric materials.

Antenna module 72 may be disposed within interior cavity 112 overlapping aperture 106. The antennas 40 in phased antenna array 54 may be aligned with aperture 106. Antenna module 72 may be separated from dielectric window 104 by gap 100 (e.g., an air gap or a gap filled with adhesive or other dielectric materials) or may be pressed against dielectric window 104 (e.g., gap 100 may be omitted). Phased antenna array 54 may convey radio-frequency signals within signal beam 108 through aperture 106 and dielectric window 104, despite the presence of conductive housing wall 102.

In implementations that are described herein as an example, the phased antenna array 54 is a linear array having N antennas 40 arranged in a co-linear manner along a shared linear axis such as linear axis 114 (e.g., the longitudinal axis of the array). Implementing phased antenna array 54 as a linear array in this way may help to minimize the width of phased antenna array 54 and thus antenna module 72 (e.g., orthogonal to linear axis 114).

When implemented as a linear array, phased antenna array 54 may steer its signal beam 108, through aperture 106, along a single degree of freedom (e.g., to the left and the right of the page of FIG. 6 as shown by arrow 110). In other words, each of the signal beams 108 in the set of signal beams 108 formable by phased antenna array is oriented at a different respective beam pointing direction along arrow 110, but each signal beam 108 in the set of formable signal beams has approximately the same orientation with respect to the axis orthogonal to linear axis 114 (e.g., into and out of the plane of the page of FIG. 6).

Conductive housing wall 102 may be any desired conductive housing wall in lower housing 12B. As one example, conductive housing wall 102 may be an angled conductive wall along the lateral periphery of lower housing 12B (e.g., an angled peripheral sidewall of lower housing 12B). The angled conductive wall may, for example, form part of a finger scoop for lower housing 12B (e.g., finger scoop 23 of FIG. 1 or a finger scoop at one of locations 19 of FIG. 1).

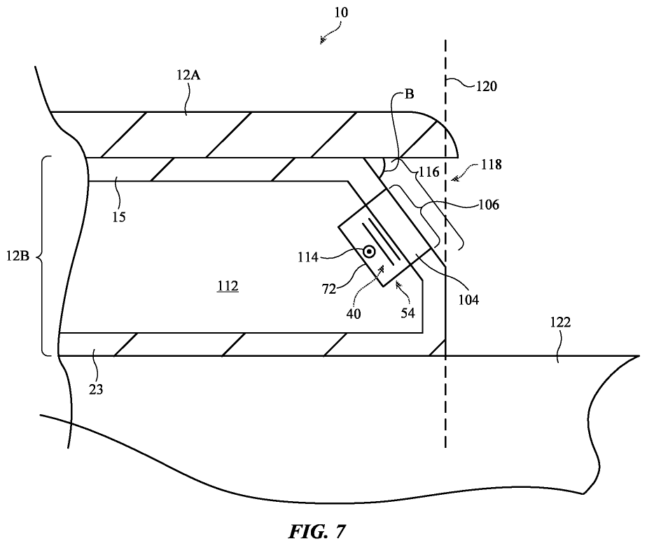

FIG. 7 is a cross-sectional side view showing how conductive housing wall 102 may be an angled conductive wall along the lateral periphery of lower housing 12B. The cross-sectional side view of FIG. 7 may, for example, be taken along line YY′ of FIG. 1 in implementations where the angled conductive wall forms part of finger scoop 23 of FIG. 1 or along one of lines XX′ of FIG. 1 in implementations where the angled conductive wall forms part of a finger scope at one of locations 19 of FIG. 1.

As shown in FIG. 7, upper conductive housing wall 15 and lower conductive housing wall 23 of lower housing 12B may extend in parallel along opposing sides of interior cavity 112 (e.g., at respective upper and lower sides of lower housing 12B). Upper conductive housing wall 15 may form an upper lateral surface, plane, or face of lower housing 12B that faces upper housing 12A. Upper housing 12A is shown in a closed position in the example of FIG. 7. When in the closed position, the lateral surface of upper housing 12A extends parallel to upper conductive housing wall 15. Lower conductive housing wall 23 may form a lower lateral surface, plane, or face of lower housing 12B. Lower conductive housing wall 23 may rest on an underlying surface 122 during use of device 10 (e.g., a desktop, tabletop, dashboard, a user's legs, or any other desired surface).

Lower housing 12B has a peripheral sidewall that couples upper conductive housing wall 15 to lower conductive housing wall 23. The peripheral sidewall may include an angled conductive wall 116. Angled conductive wall 116 may be oriented at a non-orthogonal and non-parallel angle B with respect to upper conductive housing wall 15, upper housing 12A, lower conductive housing wall 23, and/or the underlying surface 122. Put differently, angled conductive wall 116 may lie in a plane that is non-parallel with respect to a plane 120 that is orthogonal to upper conductive housing wall 15, upper housing 12A, lower conductive housing wall 23, and/or the underlying surface 122. If desired, the peripheral sidewall may include a portion that does lie within or parallel to plane 120 (e.g., a portion of the peripheral sidewall that couples angled conductive wall 116 to lower conductive housing wall 23).

Angle B may be any desired angle between 0 and 90 degrees (e.g., 10-80 degrees, 20-70 degrees, 30-60 degrees, 20-40 degrees, 20-60 degrees, 15-45 degrees, 30 degrees, 25-35 degrees, 45 degrees, etc.). Angled conductive wall 116 may be planar or may, if desired, be curved (e.g., may exhibit a non-zero curvature about a point external to device 10 as shown by finger scoop 23 in FIG. 1). Angle B may configure angled conductive wall 116 to form a recess 118 between upper housing 12A and the peripheral sidewall when housing 12A is in the closed position. Recess 118 and angled conductive wall 116 may, for example, form a finger scoop in lower housing 12B to allow upper housing 12A to more easily be rotated from the closed position to a fully open position (e.g., by insertion of an object into recess 118 and application of an upward force or torque on upper housing 12A from within recess 118). Recess 118 may, for example, form finger scoop 23 of FIG. 1 or a finger scoop at one of locations 19 of FIG. 1.

As shown in FIG. 7, angled conductive wall 116 may include aperture 106 filled with dielectric window 104 (e.g., angled conductive wall 116 may form conductive housing wall 102 of FIG. 6). Antenna module 72 may be mounted within interior cavity 112 and aligned with aperture 106 and antenna window 104. The antennas 40 in phased antenna array 54 (antenna module 72) may be arranged along linear axis 114 (e.g., into and out of the plane of the page of FIG. 7). Antennas 40 may form signal beams 108 (FIG. 6) that pass through aperture 106 and that are oriented at different respective beam pointing angles into and out of the plane of the page of FIG. 7 (e.g., along arrow 110 of FIG. 6). Tilting angled conductive wall 116 away from the underlying surface 122 by angle B allows phased antenna array 54 to also be tilted upwards and away from plane 120 and underlying surface 122. This may serve to reduce blockage of the signal beam 108 formed by phased antenna array 54 by underlying surface 122 and/or may help to prevent loading and/or other impacts on the signal beam by underlying surface 122. This may serve to optimize the overall coverage area of phased antenna array 54 and thus the wireless performance of antenna module 72 in conveying wireless data.

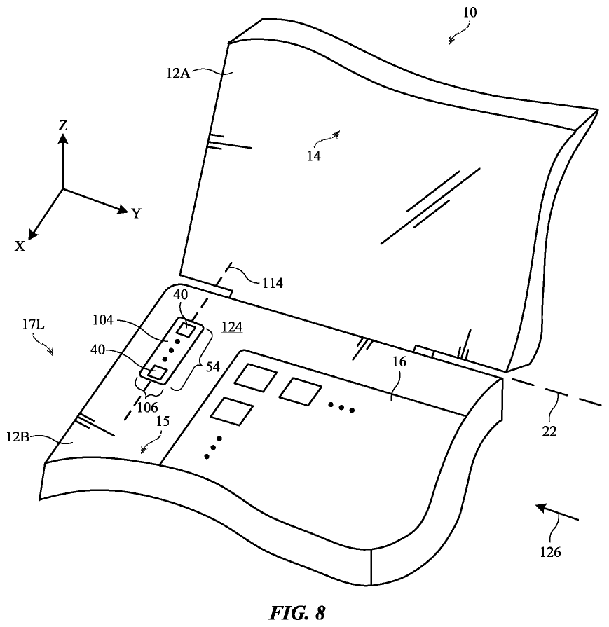

In another example, phased antenna array 54 may be aligned with an aperture 106 in upper conductive housing wall 15 of lower housing 12B. FIG. 8 is a perspective view showing how one example of how phased antenna array 54 may be aligned with an aperture 106 in upper conductive housing wall 15 of lower housing 12B. As shown in FIG. 8, upper conductive housing wall 15 of lower housing 12B may include a peripheral region 124 that extends between and/or that is laterally interposed between keyboard 16 and the lateral periphery of lower housing 12B (e.g., in the X-Y plane).

Aperture 106 may be disposed in upper conductive housing wall 15. For example, aperture 106 may be disposed in peripheral region 124 of upper conductive housing wall 15. In the example shown in FIG. 8, aperture 106 is laterally interposed between keyboard 16 and the left edge 17L of lower housing 12B. This may, for example, limit the risk that right-handed users will cover the aperture with their hand while interacting with device 10. This is illustrative and non-limiting. Alternatively, aperture 106 may be laterally interposed between keyboard 16 and the right edge 17R of lower housing 12B (FIG. 1), between keyboard 16 and the rear edge of lower housing 12B (e.g., at or facing upper housing 12A), and/or between keyboard 16 and user-facing edge 25 of lower housing 12B (FIG. 1).

As shown in FIG. 8, phased antenna array 54 may be disposed within the interior cavity of lower housing 12B and may be aligned with the aperture 106 in upper conductive housing wall 15. The linear arrangement of the antennas 40 in phased antenna array 54 may allow phased antenna array 54 to fit within the interior cavity of lower housing 12B and overlapping peripheral region 124 of upper conductive housing wall 15 even when peripheral region 124 is relatively narrow. In some implementations, the antennas 40 in phased antenna array 54 are arranged along a linear axis that extends parallel to hinge axis 22 (e.g., parallel to the Y-axis and/or the width of upper housing 12A). However, in these implementations, a substantial amount of all of the signal beams 108 (FIG. 6) formable by the phased antenna array will be undesirably blocked, cut off, and/or deteriorated by the presence of conductive material in upper housing 12A (e.g., display 14). These detrimental effects may be particularly pronounced when upper housing 12A is at lid positions with a relatively low angle with respect to lower housing 12B.

To minimize the impact of upper housing 12A on the signal beams 108 formed by phased antenna array 54, phased antenna array 54 may be oriented such that the antennas 40 in phased antenna array 54 are arranged along a linear axis 114 that extends orthogonal to hinge axis 22 (e.g., parallel to the X-axis, orthogonal to the width of upper housing 12A, and/or parallel to the central axis of lower housing 12B that extends parallel to the X-axis), as shown in FIG. 8. Orienting phased antenna array 54 in this way may greatly reduce the number of formable signal beams 108 that are impacted or blocked by upper housing 12A relative to implementations where linear axis 114 extends parallel to hinge axis 22. In addition, when phased antenna array 54 is oriented in this way, control circuitry 30 (FIG. 2) may adjust the signal beams 108 of phased antenna array 54 based on the lid position of upper housing 12A to further minimize the impact of upper housing 12A on the wireless performance of phased antenna array 54.

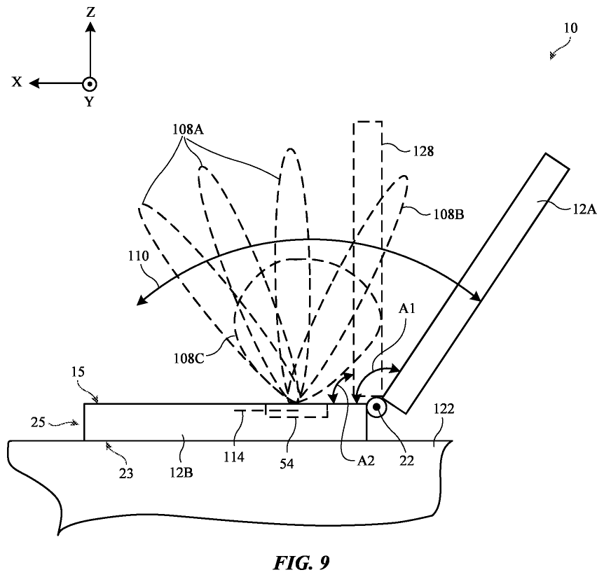

FIG. 9 is a side view (e.g., as viewed in the direction of arrow 126 of FIG. 8) showing how orienting phased antenna array 54 orthogonal to hinge axis 22 may allow control circuitry 30 (FIG. 2) to adjust the signal beams 108 of phased antenna array 54 based on the lid position of upper housing 12A in a manner that minimizes the impact of upper housing 12A on the wireless performance of phased antenna array 54.

As shown in FIG. 9, upper housing 12A may be rotated to different lid positions with respect to lower housing 12B. Each lid position may be characterized by a corresponding angle A (e.g., the angle within the X-Z plane and extending between upper conductive housing wall 15 and the lateral surface of upper housing 12A facing lower housing 12B). FIG. 9 illustrates two potential lid positions of upper housing 12A for the sake of simplicity: a first lid position at angle A1 (e.g., a fully open position) and a second lid position at an angle A2 less than angle A1 (e.g., an open position that is more closed than when upper housing 12A is in the first lid position). In general, upper housing 12A is rotatable through a range or set of different lid positions at any desired angles A (e.g., a continuous range of lid positions at different angles A within a continuous range of angles A).

Phased antenna array 54 may have a set of formable signal beams 108. Since phased antenna array 54 is a linear array having antennas 40 aligned with linear axis 114 (parallel to the X-axis), each of the signal beams 108 in the set of formable signal beams 108 is oriented at a different respective angle along arrow 110 (e.g., within the X-Z plane). When upper housing 12A is at the first lid position (e.g., angle A1), the set of formable signal beams 108 may be as large as possible without upper housing 12A blocking or interrupting the signal beams. For example, phased antenna array 54 may form any of signal beams 108A or 108B when upper housing 12A is at the first lid position while exhibiting a satisfactory level of radio-frequency performance.

On the other hand, when upper housing 12A is at the second lid position (e.g., angle A2), some of the signal beams 108 formable by phased antenna array 54 may be blocked or interrupted by upper housing 12A. For example, signal beams 108B (e.g., at relatively high angles off-boresight and towards the rear of lower housing 12B) may be blocked or interrupted by upper housing 12A while at the second lid position. However, other signal beams may still be unblocked by upper housing 12A while at the second lid position (e.g., signal beams 108A at relatively low angles off-boresight and/or at off-boresight angles towards the front of lower housing 12B). As such, phased antenna array 54 form any of signal beams 108A or 108B and may use any of signal beams 108A or 108B to convey radio-frequency signals with satisfactory levels of radio-frequency performance while upper housing 12A is in the first lid position, but may only form signal beams 108A (and not signal beams 108B) for conveying radio-frequency signals while upper housing 12A is in the second lid position. This may serve to ensure that phased antenna array 54 continues to exhibit satisfactory levels of radio-frequency performance without being blocked by upper housing 12A even as the lid position of upper housing 12A changes over time.

Additionally or alternatively, phased antenna array 54 may use signal beams of different beam widths based on the lid position of upper housing 12A. For example, signal beams having a relatively wide beam width or equivalently a relatively low gain (e.g., signal beams 108C) may be used to convey radio-frequency signals while upper housing 12A is at the first lid position (e.g., angle A1) without being blocked or interrupted by upper housing 12A. On the other hand, signal beams having a relatively narrow beam width or equivalently a relatively high gain (e.g., signal beams 108A) may be used to convey radio-frequency signals while upper housing 12A is at the second lid position (e.g., angle A2) without being blocked or interrupted by upper housing 12A.

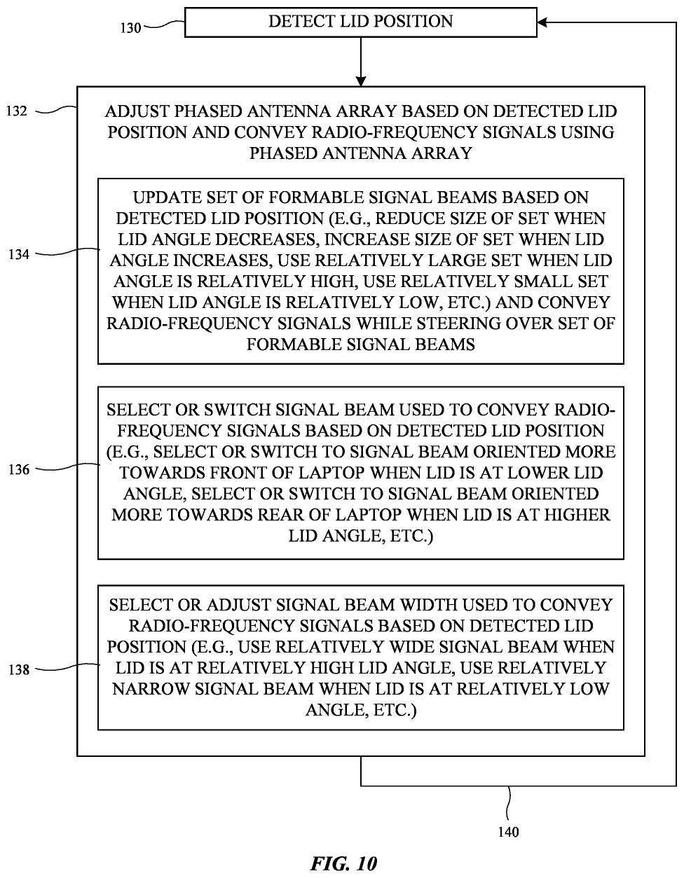

More generally, control circuitry 30 (FIG. 2) may configure, control, and/or adjust phased antenna array 54 in any desired manner based on the lid position of upper housing 12A (e.g., to minimize the impact of upper housing 12A on the performance of phased antenna array 54 at each possible lid position and even as the lid position changes over time). FIG. 10 is a flow chart of illustrative operations that may be performed by control circuitry 30 to configure, control, and/or adjust phased antenna array 54 based on the lid position of upper housing 12A.

At operation 130, lid position sensor 31 (FIG. 2) may detect, sense, compute, calculate, measure, and/or otherwise identify the lid position of upper housing 12A (e.g., the orientation of upper housing 12A relative to lower housing 12B as characterized by angle A). Control circuitry 30 may receive and/or retrieve information (e.g., sensor data) identifying the detected lid position of upper housing 12A from lid position sensor 31.

At operation 132, control circuitry 30 may set, configure, and/or adjust phased antenna array 54 in any desired manner based on the detected lid position and may use the phased antenna array to convey radio-frequency signals. For example, control circuitry 30 may perform one or more (e.g., any desired combination) of operations 134-138 to set, configure, and/or adjust phased antenna array 54 based on the detected lid position. One or more of operations 134-138 may be omitted. If desired, two or more of operations 134-138 may be performed concurrently.

At operation 134, control circuitry 30 may update the set of formable signal beams 108 for phased antenna array 54 based on the detected lid position. For example, control circuitry 30 may reduce or increase the number of signal beams formable by phased antenna array 54 based on the detected lid position. The set of formable signal beams may be larger for higher-angle lid positions (e.g., angle A1 of FIG. 9) than for lower-angle lid positions (e.g., angle A2 of FIG. 9). For example, when lid position sensor 31 senses that upper housing 12A is at angle A1, control circuitry 30 may control phased antenna array 54 to form a signal beam 108 selected from a relatively large set of signal beams such as a set of signal beams that includes both signal beams 108A and signal beams 108B of FIG. 9. On the other hand, when lid position sensor 31 senses that upper housing 12A is at angle A2, control circuitry 30 may control phased antenna array 54 to form a signal beam 108 selected from a relatively small set of signal beams such as a set of signal beams that includes signal beams 108A but not signal beams 108B of FIG. 9. Phased antenna array 54 may use any one of the signal beams from its set of formable signal beams to convey radio-frequency signals and may sweep (steer) over different signal beams in its set of formable signal beams over time. By adjusting the size of the set of formable signal beams (e.g., by adding or removing signal beams from the set of formable signal beams), the control circuitry may ensure that phased antenna array 54 only uses signal beams that are not blocked or interrupted by upper housing 12A given its present lid position.

At operation 136, control circuitry 30 may select or switch, based on the detected lid position, the active signal beam used by phased antenna array 54 to convey radio-frequency signals. For example, when lid 12A is detected at angle A2, control circuitry 30 may control phased antenna array 54 to form a signal beam 108A rather than using a signal beam 108B to convey radio-frequency signals. Additionally or alternatively, when upper housing 12A is detected at angle A2, control circuitry 30 may control phased antenna array 54 to switch from using a signal beam 108B to using a signal beam 108A to convey radio-frequency signals. Conversely, when upper housing 12A is detected at angle A1, control circuitry 30 may control phased antenna array 54 to form a signal beam 108B and/or may control phased antenna array 54 to switch from using a signal beam 108A to using a signal beam 108B to convey radio-frequency signals (e.g., when the signal beam 108B exhibits superior wireless performance than the signal beam 108A). Put differently, control circuitry 30 may set or adjust the beam pointing angle of phased antenna array based on the detected lid position. By adjusting the beam pointing angle, the control circuitry may ensure that phased antenna array 54 only uses signal beams that are not blocked or interrupted by upper housing 12A given its present lid position.

At operation 138, control circuitry 30 may select or adjust, based on the detected lid position, the width of the active signal beam used by phased antenna array 54 to convey radio-frequency signals. Control circuitry 30 may increase the beam width by decreasing the number of antennas 40 used to form the signal beam and may decrease the beam width by increasing the number of antennas 40 used to form the signal beam.

For example, when lid 12A is detected at angle A2, control circuitry 30 may control phased antenna array 54 to form a relatively narrow signal beam (e.g., a signal beam 108A of FIG. 9) rather than using a relatively wide signal beam (e.g., a signal beam 108C of FIG. 9) to convey radio-frequency signals. Additionally or alternatively, when upper housing 12A is detected at angle A2, control circuitry 30 may control phased antenna array 54 to switch from using a relatively wide signal beam to using a relatively narrow signal beam to convey radio-frequency signals. Conversely, when upper housing 12A is detected at angle A1, control circuitry 30 may control phased antenna array 54 to form a relatively wide signal beam (e.g., a signal beam 108C of FIG. 9) rather than using a relatively narrow signal beam (e.g., a signal beam 108A or 108B of FIG. 9) to convey radio-frequency signals. Additionally or alternatively, when upper housing 12A is detected at angle A1, control circuitry 30 may control phased antenna array 54 to switch from using a relatively narrow signal beam to using a relatively wide signal beam to convey radio-frequency signals. By adjusting the beam width, the control circuitry may ensure that phased antenna array 54 only uses signal beams that are not blocked or interrupted by upper housing 12A given its present lid position.

Processing may loop from operation 132 to operation 130 via path 140 to continue to update the signal beam(s) of phased antenna array 54 as the lid position of upper housing 12A changes over time.

As used herein, the term “concurrent” means at least partially overlapping in time. In other words, first and second events are referred to herein as being “concurrent” with each other if at least some of the first event occurs at the same time as at least some of the second event (e.g., if at least some of the first event occurs during, while, or when at least some of the second event occurs). First and second events can be concurrent if the first and second events are simultaneous (e.g., if the entire duration of the first event overlaps the entire duration of the second event in time) but can also be concurrent if the first and second events are non-simultaneous (e.g., if the first event starts before or after the start of the second event, if the first event ends before or after the end of the second event, or if the first and second events are partially non-overlapping in time). As used herein, the term “while” is synonymous with “concurrent.”

Device 10 may gather and/or use personally identifiable information. It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

The foregoing is merely illustrative and various modifications can be made by those skilled in the art without departing from the scope and spirit of the described embodiments. The foregoing embodiments may be implemented individually or in any combination.

What is claimed is:

1. A laptop computer comprising:
a lower housing that includes a conductive wall and a keyboard at the conductive wall;
an upper housing coupled to the lower housing by a hinge, the upper housing being rotatable relative to the lower housing about a hinge axis of the hinge;
a dielectric window in the conductive wall; and
antennas in the lower housing and overlapping the dielectric window, wherein the antennas form a phased antenna array and are arranged along a linear axis orthogonal to the hinge axis.

2. The laptop computer of claim 1, wherein the phased antenna array is a uniform linear array (ULA).

3. The laptop computer of claim 1, wherein the phased antenna array is configured to form a set of signal beams through the dielectric window, each signal beam in the set of signal beams being oriented at a different respective angle along the linear axis.

4. The laptop computer of claim 1, wherein the lower housing has a left edge, a right edge opposite the left edge, a rear edge at the hinge, and a front edge opposite the rear edge, the dielectric window being laterally interposed between the keyboard and the left edge.

5. The laptop computer of claim 1, wherein the lower housing has a left edge, a right edge opposite the left edge, a rear edge at the hinge, and a front edge opposite the rear edge, the dielectric window being laterally interposed between the keyboard and the right edge.

6. The laptop computer of claim 1, further comprising:
a finger scoop in the lower housing;
an additional dielectric window in the finger scoop; and
an additional phased antenna array overlapping the additional dielectric window in the finger scoop.

7. The laptop computer of claim 1, wherein the phased antenna array is configured to convey a signal beam of radio-frequency signals at a frequency greater than 10 GHz through the dielectric window.

8. The laptop computer of claim 7, wherein the phased antenna array is configured to adjust the signal beam based on a position of the upper housing relative to the lower housing about the hinge axis.

9. A laptop computer comprising:
a lower housing having an upper metal wall, a lower metal wall opposite the upper metal wall, and an angled metal wall that extends from the upper metal wall towards the lower metal wall at an angle that is non-parallel and non-perpendicular with respect to the upper metal wall;
a keyboard on the upper metal wall;
an upper housing coupled to the lower housing by a hinge;
a display on the upper housing;
a dielectric window in the angled metal wall; and
a phased antenna array in the lower housing and overlapping the dielectric window.

10. The laptop computer of claim 9, wherein the angled metal wall is planar.

11. The laptop computer of claim 9, wherein the angled metal wall is curved.

12. The laptop computer of claim 9, wherein the hinge has a hinge axis and the phased antenna array is a linear array having antennas arranged along a linear axis parallel to the hinge axis.

13. The laptop computer of claim 9 wherein the lower housing has a left edge, a right edge opposite the left edge, a rear edge at the hinge, and a front edge opposite the rear edge, the angled metal wall being at the left edge or the right edge.

14. The laptop computer of claim 9 wherein the lower housing has a left edge, a right edge opposite the left edge, a rear edge at the hinge, and a front edge opposite the rear edge, the angled metal wall being at the front edge.

15. The laptop computer of claim 14 wherein the lower housing comprises a finger scoop and the finger scoop comprises the angled metal wall.

16. The laptop computer of claim 9 wherein the angle is between 20 degrees and 60 degrees with respect to the upper metal wall.

17. A laptop computer comprising:
a lower housing that includes a keyboard;
an upper housing that includes a display, the upper housing being coupled to the lower housing by a hinge;
a phased antenna array in the lower housing and configured to convey radio-frequency signals;
a sensor configured to detect a position of the upper housing relative to the lower housing; and
one or more processors configured to adjust the phased antenna array based on the position detected by the sensor.

18. The laptop computer of claim 17, wherein the phased antenna array is configured to convey the radio-frequency signals using a set of signal beams formable by the phased antenna array, the one or more processors being configured to adjust a size of the set of signal beams formable by the phased antenna array based on the position detected by the sensor.

19. The laptop computer of claim 17, wherein the phased antenna array is configured to convey the radio-frequency signals within a signal beam, the one or more processors being configured to adjust an orientation of the signal beam based on the position detected by the sensor.

20. The laptop computer of claim 17, wherein the phased antenna array is configured to convey the radio-frequency signals within a signal beam, the one or more processors being configured to adjust a width of the signal beam based on the position detected by the sensor.
